(19) United States
(12) Patent Application Publication
(10) Pub. No.: US 2026/0133839 A1
(43) Pub. Date: May 14, 2026

(54) METHODS AND APPARATUS TO PROVIDE EFFICIENT TRACKING OF COMPUTER RESOURCE UTILIZATION

(71) Applicant: Intel Corporation, Santa Clara, CA (US)

(72) Inventors: Aleksei Fedotov, Ottobrunn (DE); Aleksei Kukanov, Munich (DE); Michael Joseph Voss, Austin, TX (US)

(73) Assignee: Intel Corporation, Santa Clara, CA (US)

(21) Appl. No.: 19/429,731

(22) Filed: Dec. 22, 2025

(51) Int. Cl. G06F 9/50

(52) U.S. Cl. CPC G06F 9/5027

(57) ABSTRACT

Methods and apparatus to provide efficient tracking of computer resource utilization are disclosed. An example machine readable storage medium comprising instructions to cause programmable circuitry to determine whether at least one of a first intermediate node or a second intermediate node can satisfy a first request associated with a root node, after the determination, update at least one of a first value of the first intermediate node or a first value of the second intermediate node and a second value of the root node, determine whether a first child node can satisfy a second request associated with the first child node, and after a determination that the first child node can satisfy the second request, update a first value of the first child node, a second value of the first intermediate node, and the second value of the root node.

### BACKGROUND

Modern processors achieve high performance by running multiple software threads in parallel. Each software thread represents an independent sequence of instructions, and the hardware (e.g., central processing unit (CPU)) executes as many software threads simultaneously as it has hardware threads, typically one per core, or, with Simultaneous Multithreading (SMT), one per hyper-thread (e.g., logical core). For many applications, performance is highest when the number of running threads is close to (e.g., or exactly equal to) the number of available hardware threads.

### BRIEF DESCRIPTION OF THE DRAWINGS

FIG. 1 is a block diagram of an example environment in which example resource management circuitry operates to track computer resource utilization.

FIG. 2 is a block diagram of an example implementation of the resource management circuitry of FIG. 1.

FIG. 3 is a diagram of an example tree-based data structure to be implemented by the resource management circuitry of FIG. 1.

FIG. 4 is a diagram of the tree-based data structure of FIG. 3 including a first and second request.

FIG. 5 is a diagram of the tree-based data structure of FIG. 4 including a third request.

FIGS. 6A-6D include a flowchart representative of example machine readable instructions and/or example operations that may be executed, instantiated, and/or performed by example programmable circuitry to implement the resource management circuitry of FIG. 2.

FIG. 7 is a block diagram of an example processing platform including programmable circuitry structured to execute, instantiate, and/or perform the example machine readable instructions and/or perform the example operations of FIGS. 6A-6D to implement the resource management circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 6A-6D) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts.

### DETAILED DESCRIPTION

Modern processors run software threads in parallel, and performance is typically highest when the number of running threads matches the number of hardware threads. When applications combine independent parallel frameworks or trigger nested parallelism, they often create more threads than the hardware can execute simultaneously. This oversubscription leads to reduced effective central processing unit (CPU) time per thread, increased switching overhead, and degraded performance.

To make parallel programming easier, developers often rely on parallel framework libraries. These frameworks create and manage pools of worker threads, hiding the complexity of scheduling, partitioning, and load balancing. However, these frameworks generally do not coordinate with each other, and each assumes it is the only system responsible for parallel work. When such libraries are combined in a single application, especially if they are used by independent components or nested parts of the code, they may each create their own full-size thread pool. Implementation of multiple thread pools can lead to situations where an application requests more software threads than the number of available hardware threads or hyper-threads.

Implementation of multiple thread pools becomes especially problematic with nested parallelism, where a parallel region triggers another parallel region inside it. In such cases, the total number of requested threads may multiply at each level of nesting, causing a relatively large thread growth. Once the number of software threads exceeds the number of hardware threads, the operating system scheduler multiplexes them. The operating system does this by giving each thread a time slice and rapidly switching between them. Multiplexing software threads introduces two major sources of overhead, reduced effective CPU time per thread and increased switching costs. With more software threads than hardware threads, each thread is assigned a smaller fraction of CPU time over a given period, which reduces throughput and efficiency. Further, switching between threads is not free. The operating system (OS) must save and restore its register state, update metadata, and manage caches. When switches become too frequent, the overhead can grow large enough that adding more threads makes the software run slower.

Some solutions that attempt to prevent oversubscription in parallel programs count how many software threads are active, and do not model the hardware itself. For example, they do not model cores, NUMA domains, or other topology details of the hardware. As such, these systems cannot make informed decisions about where threads should run or how many can run efficiently. Other systems utilize low-level substrates for composing parallel computations, allowing different parallel components to coordinate thread usage. However, these systems use software-level coordination rather than tracking or modeling the actual hardware resources being consumed.

Examples described herein may overcome some or all of the above described challenges. Examples described herein provide for resource management circuitry which utilizes a tree-based data structure for computer resource management. The tree-based data structure includes counters for total resource capacity of a node, for resources utilized at the node, and for resources utilized at sub-nodes of the node. Examples described herein provide for tracking of resource utilization and prevention of resource oversubscription, resulting in an overall improvement of effective system utilization.

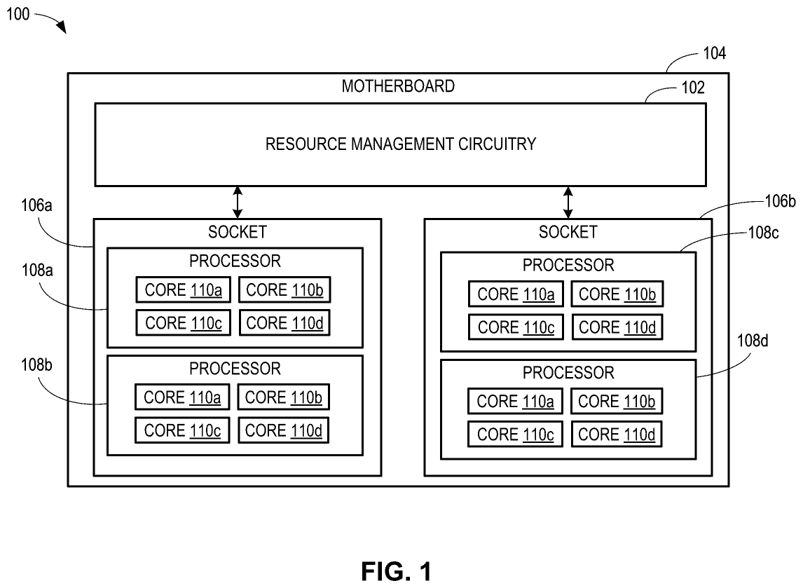

FIG. 1 is a block diagram of an example environment 100 in which resource management circuitry 102 operates to track computer resource utilization. The environment 100 includes an example motherboard 104 including the resource management circuitry 102, a first socket 106a and a second socket 106b. The first socket 106a includes a first processor 108a and a second processor 108b. The second socket 106b includes a third processor 108c and a fourth processor 108d. Each of the processors 108a-d include four cores 110a-d. In the illustrated example of FIG. 1, the first socket 106a and the second socket 106b are coupled to and in communication with the resource management circuitry 102.

While in the illustrated example of FIG. 1 the resource management circuitry 102 is integral to the motherboard 104, in some examples the resource management circuitry 102 can be located on its own printed circuit board (PCB) or on a PCB associated with the motherboard. Likewise, while in the illustrated example the first socket 106a and the second socket 106b are located integral to the motherboard, the first and second sockets 106a-b can be located elsewhere. Further, while the processors 108a-d each include four cores 110a-d, in some examples the processors can include more or less than four cores (e.g., 1, 2, 3, 5, 6, etc.). Similarly, the sockets 106a-b can include more or less than two processors 108a-d.

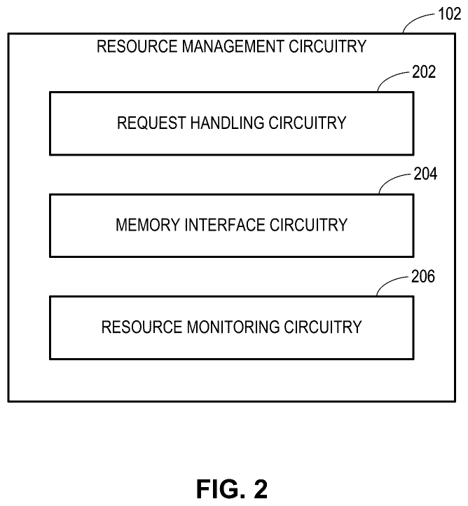

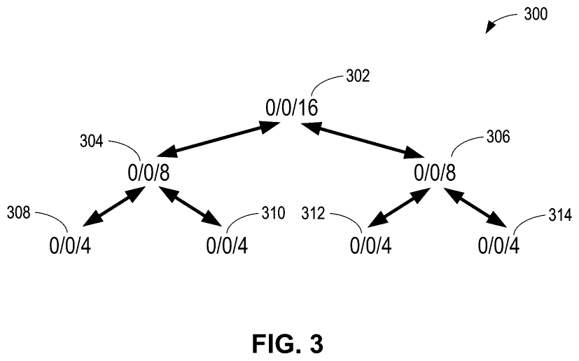

FIG. 2 is a block diagram of an example implementation of the resource management circuitry 102 of FIG. 1. In the illustrated example, the resource management circuitry 102 includes request handling circuitry 202, memory interface circuitry 204, and resource monitoring circuitry 206. The request handling circuitry 202 receives, manages, and tracks requests from software associated with the motherboard 104. The memory interface circuitry 204 receives instructions from the request handling circuitry 202 to update a tree-based data structure 300 (FIG. 3) based on the requests received by the request handling circuitry 202. Further, the resource monitoring circuitry 206 monitors hardware usage of the motherboard 104, or more specifically, the sockets 106a-b and the processors 108a-d.

The request handling circuitry 202 operates to manage and track the requests by utilizing the tree-based data structure 300 as shown in reference to FIG. 3. In the illustrated example, the tree-based data structure 300 includes a parent (e.g., root) node 302, a first intermediate node 304, and a second intermediate node 306. The first intermediate node 304 includes a first child node 308 and a second child node 310. Further, the second intermediate node 306 includes a third child node 312 and a fourth child node 314. In the illustrated example, the parent node 302 is associated with the motherboard 104, the first and second intermediate nodes 304-306 are associated with the sockets 106a-b, and the child nodes 308-314 are associated with the processors 108a-d.

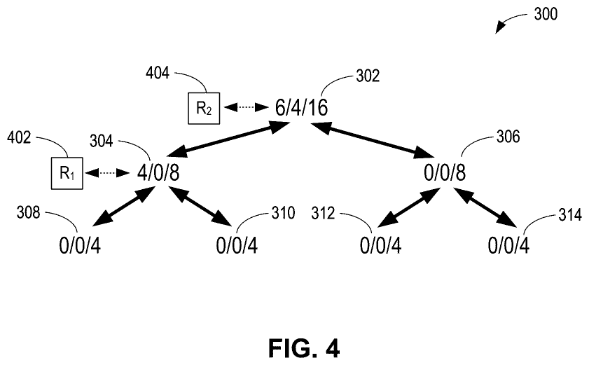

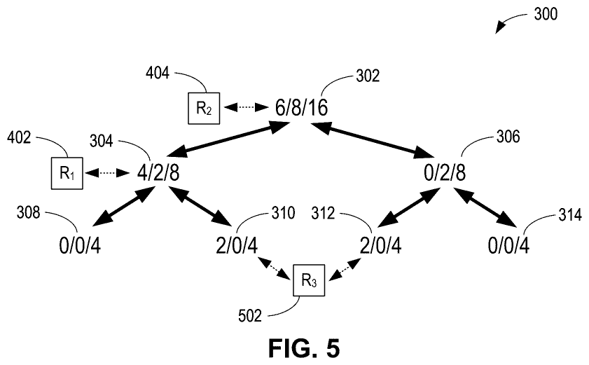

Each of the nodes 302-314 include a first, second, and third value associated with the respective node. The first value (e.g., a node resource utilization counter) is associated with resources utilized at the node 302-314. For example, a first value associated with the first intermediate node 304 has a maximum value of eight and a minimum value of zero because the first intermediate node 304 is associated with a combined eight cores (e.g., the cores 110a-d associated with each of the first and second processor 108a-b). In the illustrated example of FIG. 3 the first value of the first intermediate node 304 is zero, indicating that no resources are currently being requested (e.g., utilized, assigned) at the first intermediate node 304. The second value (e.g., a sub-node resource utilization counter) is associated with resources utilized in sub-nodes of the node 302-314. For example, a second value associated with the first intermediate node has a maximum value of eight and a minimum value of zero because the first intermediate node 304 is associated with the first child 308 and the second child 310 (e.g., sub-nodes) which include the combined eight cores. In the illustrated example, the second value of the first intermediate node 304 is zero, indicating that no resources are currently being requested (e.g., utilized, assigned) at either the first child node 308 or the second child node 310. Further, the third value (e.g., a total resource capacity counter) is associated with total resource capacity at the node 302-314. For example, a third value associated with the first intermediate node is eight because the first intermediate node 304 is associated with the combined eight cores. The first, second, and third values will be discussed in further detail in reference to FIGS. 4 and 5.

The request handling circuitry 202 receives a variety of requests associated with the motherboard 104. For example, the request handling circuitry 202 can receive a first request associated with the parent node 302. In such example, the request is not directed towards a specific socket 106a-b or a specific processor 108a-d. This means that the request handling circuitry 202 can use (e.g., assign, utilize, map, etc.) any of the cores 110a-d associated with any of the processors 108a-d to fulfill the first request. In other examples, the request handling circuitry 202 can receive a second request associated with a specific intermediate node (e.g., either the first intermediate node 304 or the second intermediate node 306). In such an example, the request handling circuitry 202 must use the resources (e.g., processors) of the indicated first intermediate node 304 or the second intermediate node 306. Alternatively, in examples where the request handling circuitry 202 receives a third request associated with a specific one of the processors 108a-d, the request handling circuitry must use the requested one of the processors 108a-d to fulfill the third request.

FIG. 4 is a diagram of the tree-based data structure 300 of FIG. 3 including a first (R1) and second (R2) request 402-404. In the illustrated example, the request handling circuitry 202 receives the first request 402. The first request 402 is associated with the first intermediate node 304. To determine whether the first intermediate node 304 can accommodate the first request 402, the request handling circuitry 202 compares a number of resources associated with the first request 402 (e.g., four in the illustrated example), the first value, and the second value associated with the first intermediate node 304 to the third value associated with the first intermediate node 304. Prior to the first request 402, the first value was zero, the second value was zero, and the third value was eight. Likewise, in this example, the request handling circuitry 202 determines that the first intermediate node 304 has eight total resources and none are currently being utilized either at the first intermediate node 304, the first child node 308, or the second child node 310, so the first request 402 can be satisfied.

After the request handling circuitry 202 has determined that the first request 402 can be satisfied by the first intermediate node 304, the request handling circuitry 202 generates a signal (e.g., issues a signal, issues a command, etc.) to the memory interface circuitry 204 to cause the memory interface circuitry 204 to update the tree-based data structure 300 to reflect the resources utilized by the first request 402. For example, the memory interface circuitry 204 updates the first value of the first intermediate node 304 to equal four. Additionally, the memory interface circuitry 204 updates the second value of the parent node to equal four.

In the illustrated example, the request handling circuitry 202 further receives the second request 404. The second request 404 is associated with the parent node 302. Further, the second request 404 is associated with six resources (e.g., cores). To determine whether the parent node 302 can accommodate the second request 404, the request handling circuitry 202 compares the number of resources associated with the second request 404 (e.g., six), a first value, and a second value associated with the parent node 302 to a third value associated with the parent node 302. Prior to the second request 404, the first value was zero, the second value was four (e.g., because the first intermediate node is currently utilizing four cores), and the third value was sixteen. Likewise, in this example, the request handling circuitry 202 determines that the parent node 302 has sixteen resources and four are currently being utilized either at the first intermediate node 304 or the second intermediate node 306, so the second request 404 can be satisfied.

After the request handling circuitry 202 has determined that the second request 404 can be satisfied by the parent node 302, the request handling circuitry 202 generates a signal (e.g., issues a signal, issues a command, etc.) to the memory interface circuitry 204 to cause the memory interface circuitry 204 to update the tree-based data structure 300 to reflect the resources utilized by the second request 404. For example, the memory interface circuitry 204 updates the first value of the parent node 302 to equal six.

FIG. 5 is a diagram of the tree-based data structure of FIG. 4 including a third request 502. The third request 502 includes a request for resources at the second and third child nodes 310-312. To determine whether the second and third child nodes 310-312 can satisfy the third request 502, the request handling circuitry 202 compares the requested amount of resources with the sum of available resources from the affected nodes. For example, the request handling circuitry 202 first determines whether the second child node 310 can satisfy a first portion (e.g., two computer resources) of the resources requested (e.g., four total resources) in the third request 502. To determine whether the second child node 310 can accommodate the first portion of the third request 502, the request handling circuitry 202 compares the number of resources associated with the first portion (e.g., the portion of the third request requesting resources of the second child node 310, two computer resources) of the third request 502, a first value, and a second value associated with the second child node 310 to a third value associated with the second child node 310. Prior to the third request 502, the first value was zero, the second value was zero, and the third value was four. In this example, the request handling circuitry 202 determines that the second child node 310 has a capacity of four resources and zero are currently being utilized, so the first portion of the third request 502 can be satisfied.

Next, the request handling circuitry 202 determines whether the third child node 312 can satisfy a second portion of the resources requested (e.g., two computer resources) in the third request 502. To determine whether the third child node 312 can accommodate the second portion of the third request 502, the request handling circuitry 202 compares the number of resources associated with the second portion of the third request 502 (e.g., two), a first value, and a second value associated with the third child node 312 to a third value associated with the third child node 312. Prior to the third request 502, the first value was zero, the second value was zero, and the third value was four. In this example, the request handling circuitry 202 determines that the third child node 312 has a capacity of four resources and zero are currently being utilized, so the second portion of the third request 502 can also be satisfied.

The request handling circuitry 202 verifies that both the second child node 310 and the third child node 312 can satisfy the third request 502. If either of the second child node 310 or the third child node 312 cannot satisfy the third request 502, the request handling circuitry 202 marks the third request 502 as not satisfied. In some examples, if the third request 502 is marked as not satisfied, the request handling circuitry 202 places the third request 502 in a queue until the third request 502 can be satisfied. In other examples, before the third request 502 is marked as not satisfied, the request handling circuitry 202 attempts to shift portions of already satisfied requests which were previously associated with the second child node 310 or the third child node 312. In such an example, the request handling circuitry 202 will try to accommodate the third request 502 before adding the third request 502 to the queue or marking it as not satisfied. After determining the first portion and the second portion of the third request 502 can be satisfied by the second and third child nodes 310-312, the request handling circuitry 202 generates a signal (e.g., issues a signal, issues a command, etc.) to the memory interface circuitry 204 to cause the memory interface circuitry 204 to update the tree-based data structure 300 to reflect the resources utilized by the third request 502. For example, the memory interface circuitry 204 updates the first value of the second and third child nodes 310-312 to equal 2. Further, the memory interface circuitry 204 updates the second value of the first and second intermediate nodes 304-306 to equal two. Additionally, the memory interface circuitry 204 updates the second value of the parent node to increase it by four (e.g., equal 8).

Referring to FIG. 2., the resource monitoring circuitry 206 operates to cause the memory interface circuitry 202 to update the tree-based data structure 300 based on the requests 402, 404, 502 being fulfilled (e.g., completed). For example, after completion of the third request 502, the resource monitoring circuitry 206 causes the memory interface circuitry 202 to update the tree-based data structure 300 to reflect the resource utilized on the motherboard 104.

The tree-based data structure 300 can also be modified. For example, the tree-based data structure 300 can be modified by the following operations:

adjust_node_resources(node, num); (1)
can_satisfy(node, resources_demand); (2)
get_available_resources(node); (3)
insert(request, array of [node, grant]); (4)
remove(request); (5)
move_request(request, array of [from_node, to_node, num_resources]); (6)

In some examples, the first operation (1) adjusts counters of a node based on assignment of its resources. For example, the first operation (1):

```
adjust_node_resources(node, num)
{
  node.satisfied += num;
  while(node.super_node)
  {
    node = node.super_node;
    node.satisfied_at_subnodes += num;
  }
}
```

In the first operation (1) node.satisfied refers to the first value associated with the node and node.satisfied_at_subnodes refers to the second value. The first operation (1) updates the counters that a node of the tree-based data structure 300 includes. The first operation (1) receives a node from which to start the updating process and the value of the change. To hold the invariants of the tree-based data structure 300 the first operation (1) should also adjust the counters for all nodes above the current node in the tree-based data structure 300.

The second operation (2) checks if a node can satisfy demand for a certain number of resources. For example, the second operation (2):

```
boolean can_satisfy(node, demand)
{
  total_demand = node.satisfied + node.satisfied_at_subnodes + demand;
  is_satisfiable = (total_demand <= node.capacity);
  return is_satisfiable;
}
```

The second operation (2) returns true or false answering the question whether a certain number of resources (e.g., demand) are available in a given node. For example, node.satisfied refers to the first value of a node (e.g., the parent node), node.satisfied_at_subnodes refers to the second value of a node, and demand refers to the amount of resources requested at the node. These values are used to determine if a node can satisfy a request for resources.

Further, the third operation (3) retrieves a number of resources available at a node. For example, the third operation (3):

integer get_available_resources(node)
{
return node.capacity − node.satisfied − node.satisfied_at_subnodes;
}

The third operation (3) determines how many resources of a certain node are currently unoccupied. The third operation (3) subtracts the number of occupied resources on the level of the given node and its sub nodes from the capacity of the node.

The fourth operation (4) inserts a satisfied request. For example, the fourth operation (4):

```
insert(request, array of [node, grant])
{
  for each [n, g] in array of [node, grant]
  {
    associate_as_satisfied(request, n, g);
    adjust_node_resources(n, g);
  }
}
```

The fourth operation (4) assumes, as a precondition, that there is available capacity for the request being inserted. The fourth operation (4) receives a request and an array of {node, grant} pairs. The fourth operation (4) goes over the pairs and assigns the prescribed number of resources grant from each node to the request. Each node passed to the fourth operation (4) is the node at which the insertion of the request happens. For example, referring to FIG. 5, the third request 502 is associated with two child nodes 310-312, while the first request 402 is associated with an intermediate node. When inserting the third request 502, there would be the two child nodes 310-312 specified as node parameter in the pairs, while when inserting the first request 402, there would be a single pair for that one intermediate node.

The fifth operation (5) removes a request from the tree based data structure 300. For example, the fifth operation (5):

```
integer remove(request)
{
  released_num = 0;
  for each node in request.nodes
    num = get_grant(request, node);
    released_num += num;
    disassociate(request, node);
    adjust_node_resources(node, −num);
  }
  return released_num;
}
```

The fifth operation (5) is the opposite to the fourth operation (4). The fifth operation (5) receives a request to remove from the tree-based data structure 300. Then, iterating through associated nodes, the fifth operation (5) retrieves the number of resources that were assigned to the request from the node, and uses this information to adjust the utilization counters for the node and all nodes above it. The fifth operation (5) also disassociates the request with each node it was associated with and returns the overall number of resources that were assigned to it.

The sixth operation (6) moves resources between nodes from which a request is associated. For example, the sixth operation (6):

```
move_request(request, array of [from_node, to_node, num])
{
  for each [from, to, n] in array of [from_node, to_node, num] {
    g = get_grant(request, from);
    associate_as_satisfied(request, from, g − n);
    adjust_node_resources(from, −n);
    g = get_grant(request, to);
    associate_as_satisfied(request, to, g + n);
    adjust_node_resources(to, n);
  }
}
```

In the sixth operation (6), the function associate_as_satisfied associates a request with a node as satisfied and grants the specified number of resources from that node to the request. The function associate_as_satisfied considers the amount of resources already granted to the request from the specified node. Further, the function associate_as_satisfied grants the specified amount of resources as the overall amount of resources granted to the request from that node. All such modifications happen with updates to the corresponding counters of the node and request. For example, if by the time the function associate_as_satisfied is called the request was already associated with the node and was granted five resources, and the function associate_as_satisfied is called with seven resources as its last argument, the function associate_as_satisfied grants two more resources to the request. The sixth operation (6) reassigns the resources granted to a request from one set of associated nodes to another. The sixth operation (6) receives request whose resources are to be moved, and an array of items, where each item consists of a node from which to move resources (from_node), a node where to move the resources (to_node), and the number of resources to move (num). The sixth operation (6) assumes that each node is from a set of nodes associated with the request. Furthermore, the sixth operation (6) assumes that there is available capacity in each to_node to grant corresponding number of resources num from the node to the request.

Some requests can be satisfied using the currently available capacity, some may only be satisfied if the tree-based data structure 300 is rebalanced to shift previously assigned resources, and some cannot be satisfied until resources have been released by previously satisfied requests. Example operations to satisfy each of these three scenarios is as follows:

```
add(request)
{
  intersecting_nodes{root}; non_intersecting_nodes{ };
  continue_search = true;
  while (continue_search)
  {
    is_satisfiable = try_satisfy(intersecting nodes, non_intersecting
nodes, request);
    if (insert_at_this_level(intersecting_nodes, request)) {
      continue_search = false;
    } else {
      [intersecting_nodes, non_intersecting nodes] =
filter_children(intersecting_nodes, non_intersecting_nodes, request.mask);
    }
  }
  if (is_satisfiable)
  {
    array of [node, grant] =
find_resources_distribution(request.num, intersecting_nodes);
    insert(request, array of [node, grant]);
  } else {
    for each node in intersecting_nodes
    {
      associate_as_unsatisfied(request, node);
    }
  }
}
```

When a new request comes, it goes down the tree-based data structure 300 from its root. Going down the tree-based data structure 300 from its root enables optimal tracking of resource utilization. For example, going from the bottom of the tree-based data structure 300 to the top could cause the add (request) operation to not immediately determine whether a request can be satisfied. At each level of the search, the nodes are separated into two non-overlapping sets, intersecting_nodes and non_intersecting_nodes. The intersecting_nodes represent resources that fully or partially overlap with the set of resources in the request, these are the ones which can possibly satisfy the request. The set of resources represented by the non_intersecting_nodes do not overlap with those of the request.

In the add (request) operation, the function try_satisfy tries to satisfy the specified request. The function try_satisfy accepts the nodes whose resources are not requested (e.g., non_intersecting_nodes) by the request. Together, intersecting_nodes and non_intersecting_nodes represent all of the nodes on a single layer of the tree-based data structure 300. If there is not enough available capacity in the intersecting_nodes the function try_satisfy tries to shift some of the resources from portions of already satisfied requests associated with the nodes from the intersecting_nodes set to the corresponding portions of those satisfied requests that are associated with the nodes in the non_intersecting_nodes set. Thus, making room (e.g., finding resources) for the request being satisfied. The function try_satisfy returns a boolean status indicating whether it was successful in finding the resources for the request being satisfied.

In some examples, if there is not enough available capacity in the intersecting_nodes set, the algorithm tries to shift some of the resources assigned in this set to the nodes in the non_intersecting_nodes set (e.g., if their capacity allows) by reassociating already satisfied requests from the former set to the latter one.

Next, the call to the insert_at_this_level operation determines whether an algorithm should satisfy the request using the intersecting_nodes set (e.g., by returning true) or if it should go deeper down the tree-based data structure 300 to the sub-nodes of those (e.g., by returning false). For example, the insert_at_this_level operation can check if the requested resources are fully contained within only a partial set of the sub-nodes. If the insert_at_this_level operation decides to go with deeper nodes of the tree-based data structure 300, an operation filter_children populates intersecting_nodes and non_intersecting_nodes sets for the next level of the tree-based data structure 300, and the process repeats starting from the operation try_satisfy.

When it becomes clear that a request for resources can be satisfied, it must be determined what number of resources to assign to the request from each of the suitable nodes. The find_resources_distribution operation accepts the number of resources and the intersecting set of nodes and builds a distribution prescription, an array of pairs, where each pair contains the number of resources to assign and the node from which this number of resources to take. Then the request is inserted in the tree-based data structure 300 as satisfied.

In the event that the request cannot be satisfied by the currently available capacity, it is associated with the nodes at the level where it would have been inserted, but as an unsatisfied request, using the associate_as_unsatisfied operation.

To release a previously satisfied request, the following operations can be utilized:

```
release(request
{
  num_resources_released = remove(request);
  available_resources = get_available_resources(root);
  unsatisfied_requests = get_unsatisfied_requests( );
  while (available_resource > 0 and unsatisfied_requests not empty)
  {
    ur = pop_next_unsatisfied(unsatisfied_requests);
    if (can_satisfy(root, ur.num))
    {
      for each node in ur.nodes
      {
        disassociate(ur, node);
      }
      add(ur);
      available_resources = get_avaialble_resources(root);
    }
  }
}
```

The release operation first removes the request from the tree-based data structure 300. Then the release operation goes over a set of unsatisfied requests and tries to satisfy those one by one while resources are available. Once a request to satisfy is chosen, the call to the can_satisfy operation checks if the available resources are sufficient. If the available resources are sufficient, the previous associations for the request are removed and the operation attempts to satisfy it by calling the insertion algorithm. Associating a request with a node means linking the node and the request. For example, having access to information regarding the node enables the request handling circuitry 202 to determine all requests associated with the respective node.

The resource management circuitry 102 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the resource management circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

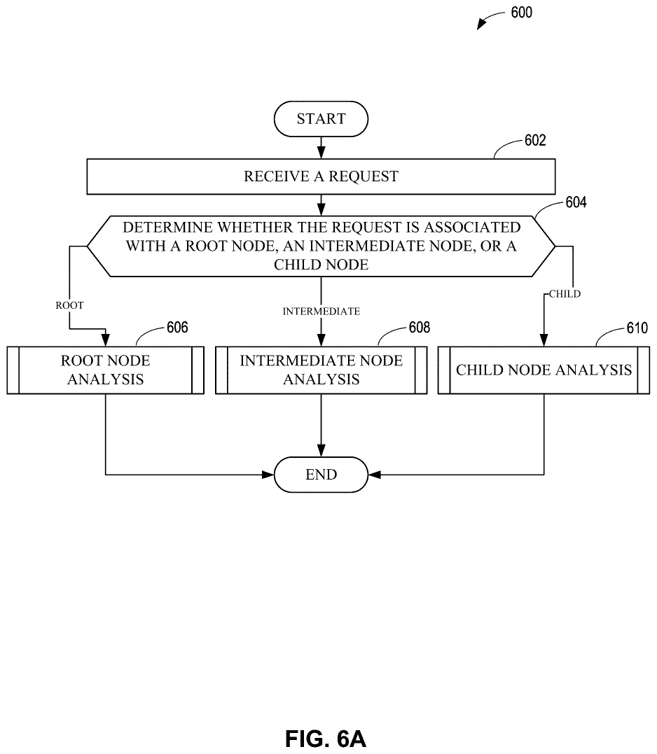

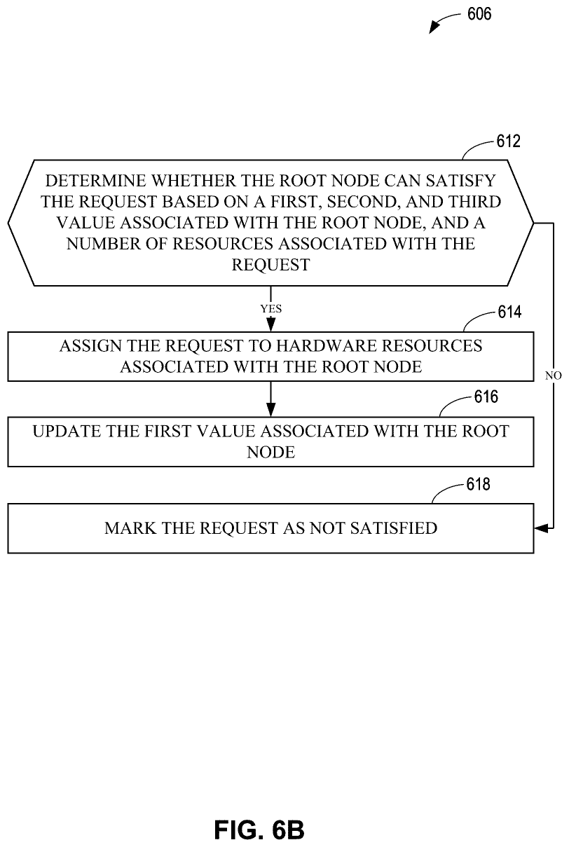

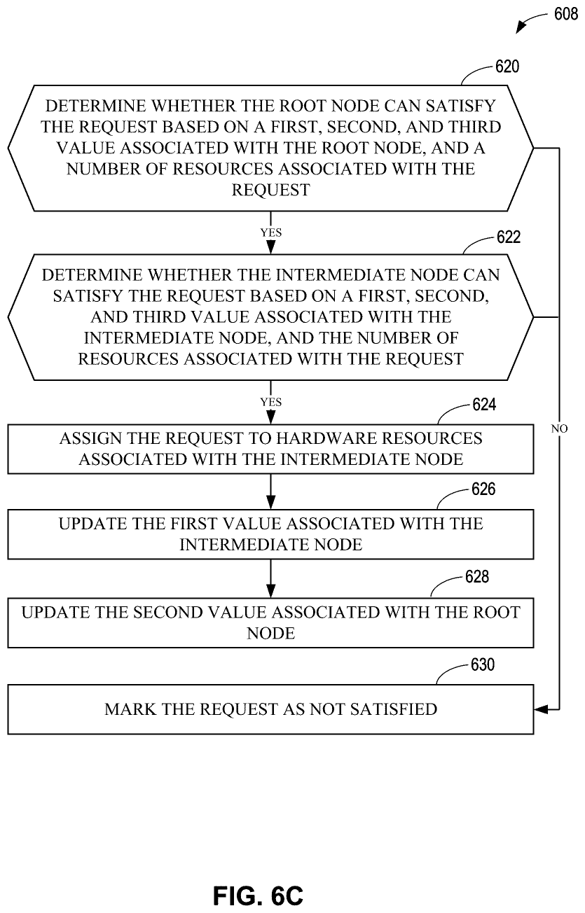

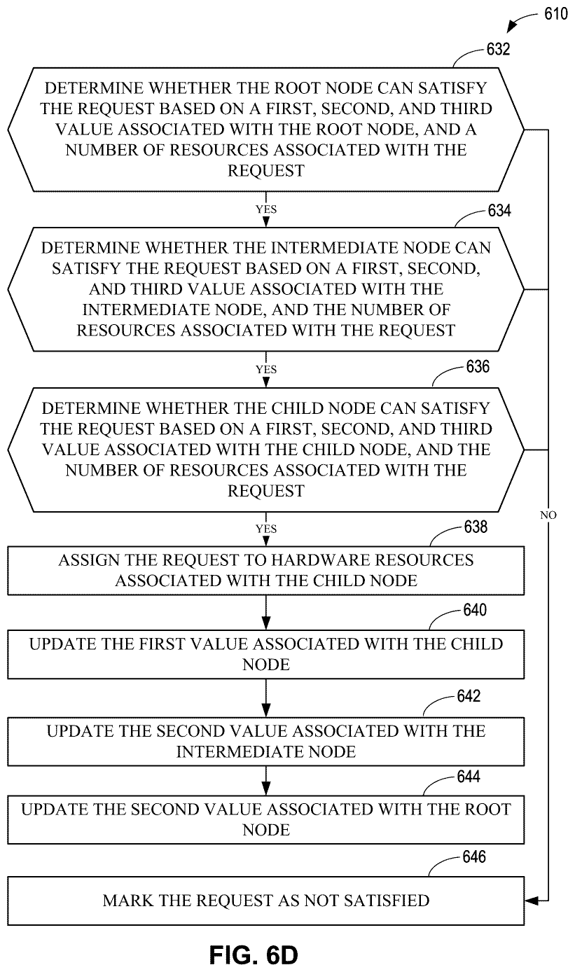

In some examples, the request handling circuitry 202 is instantiated by programmable circuitry executing request handling circuitry instructions and/or configured to perform operations such as those represented by the flowchart(s) of FIGS. 6A-6D.

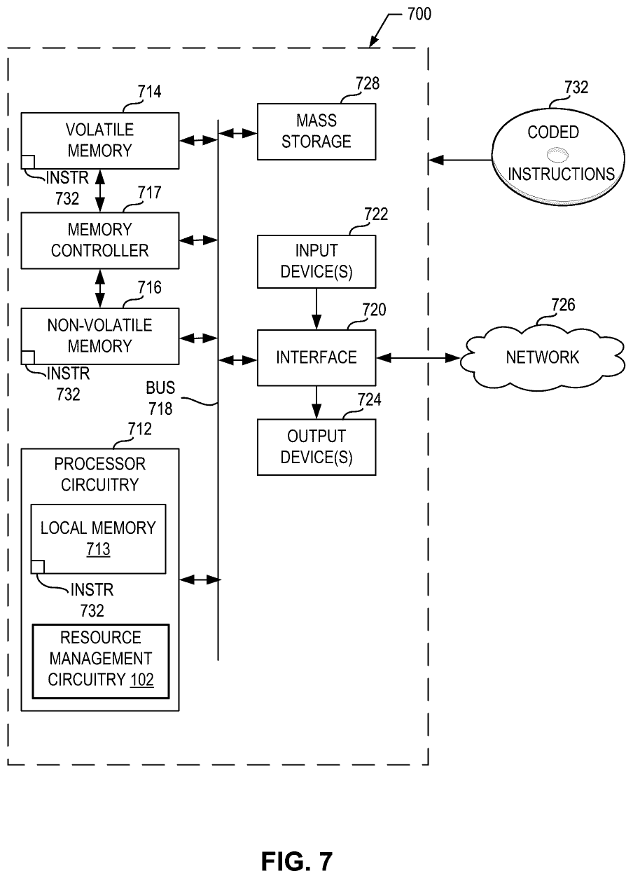

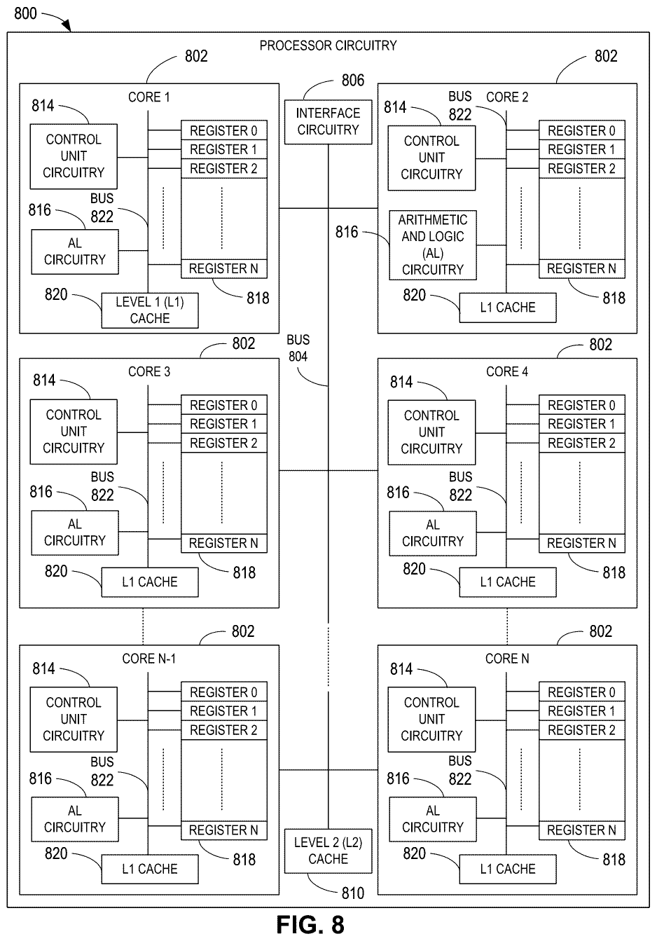

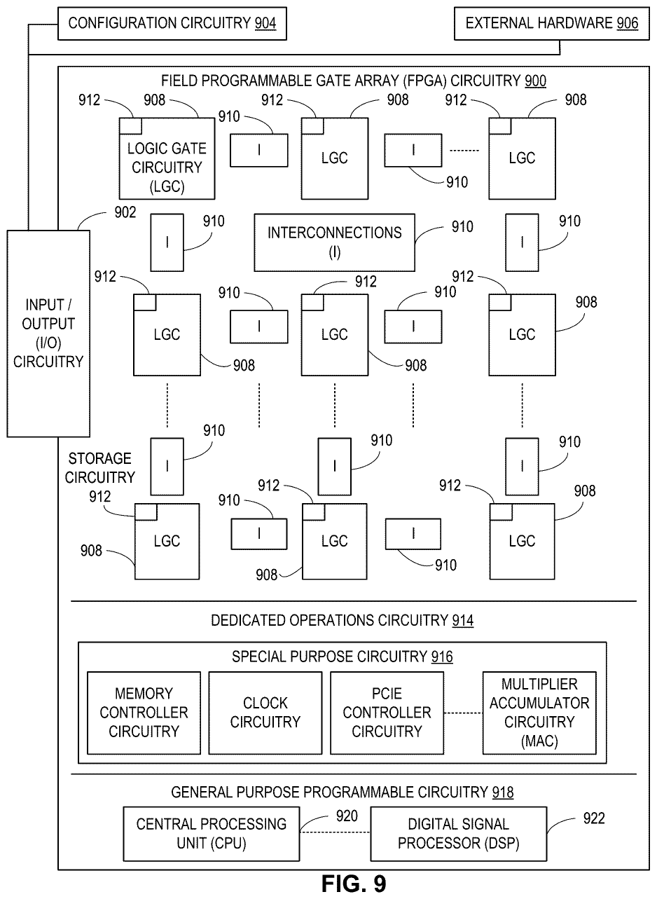

In some examples, the resource management circuitry 102 includes means for request handling. For example, the means for request handling may be implemented by the request handling circuitry 202. In some examples, the request handling circuitry 202 may be instantiated by programmable circuitry such as the example programmable circuitry 712 of FIG. 7. For instance, the request handling circuitry 202 may be instantiated by the example microprocessor 800 of FIG. 8 executing machine executable instructions such as those implemented by at least blocks 602-614, 620-624, and 632-638 of FIGS. 6A-6D. In some examples, the request handling circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the request handling circuitry 202 may be instantiated by any other combination of hardware, software, and/or firmware. For example, the request handling circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the memory interface circuitry 204 is instantiated by programmable circuitry executing memory interface circuitry instructions and/or configured to perform operations such as those represented by the flowchart(s) of FIGS. 6A-6D.

In some examples, the resource management circuitry 102 includes means for interfacing with a memory. For example, the means for interfacing may be implemented by the memory interface circuitry 204. In some examples, the memory interface circuitry 204 may be instantiated by programmable circuitry such as the example programmable circuitry 712 of FIG. 7. For instance, the memory interface circuitry 204 may be instantiated by the example microprocessor 800 of FIG. 8 executing machine executable instructions such as those implemented by at least blocks 616, 618, 626-630, and 640-646 of FIGS. 6A-6D. In some examples, the memory interface circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the memory interface circuitry 204 may be instantiated by any other combination of hardware, software, and/or firmware. For example, the memory interface circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the resource monitoring circuitry 206 is instantiated by programmable circuitry executing resource monitoring circuitry instructions and/or configured to perform operations such as those represented by the flowchart(s) of FIGS. 6A-6D.

In some examples, the resource management circuitry 102 includes means for resource monitoring. For example, the means for resource monitoring may be implemented by the resource monitoring circuitry 206. In some examples, the resource monitoring circuitry 206 may be instantiated by programmable circuitry such as the example programmable circuitry 712 of FIG. 7. For instance, the resource monitoring circuitry 206 may be instantiated by the example microprocessor 800 of FIG. 8 executing machine executable instructions such as those implemented by at least blocks 618, 630 and 646 of FIGS. 6A-6D. In some examples, the resource monitoring circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the resource monitoring circuitry 206 may be instantiated by any other combination of hardware, software, and/or firmware. For example, the resource monitoring circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the resource management circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example request handling circuitry 202, the example memory interface circuitry 204, the example resource monitoring circuitry 206, and/or, more generally, the example resource management circuitry 102 of FIG. 2, may be implemented by hardware alone or by hardware in combination with software and/or firmware. Thus, for example, any of the example request handling circuitry 202, the example memory interface circuitry 204, the example resource monitoring circuitry 206, and/or, more generally, the example resource management circuitry 102, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example resource management circuitry 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the resource management circuitry 102 of FIG. 2 and/or representative of example operations which may be performed by programmable circuitry to implement and/or instantiate the resource management circuitry 102 of FIG. 2, are shown in FIGS. 6A-6D. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6A-6D, many other methods of implementing the example resource management circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6A-6D may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIGS. 6A-6D include a flowchart representative of example machine readable instructions and/or example operations 600 that may be executed, instantiated, and/or performed by programmable circuitry to track computer resource utilization. The example machine-readable instructions and/or the example operations 600 of FIG. 6A begin at block 602 at which the request handling circuitry 202 receives a request for computer resources.

At block 604 the request handling circuitry 202 determines whether the request is associated with a root node, an intermediate node, or a child node. For example, the request can be associated with the motherboard 104, one of the sockets 106a-b, or ones of the processors 108a-d. In some examples, if the request does not specify a particular node level or a node level identified by the request is not able to be satisfied or is otherwise not accepted, then the request handling circuitry 202 will treat the request as if it was associated with the root node. For example, in some implementations requests may not be implemented to identify a particular node level or specifying the node level may be an option parameter for a request. When the node level is not predefined by the request, the request handling circuitry 202 will perform a top to bottom search as illustrated in FIGS. 6A-6D and as described above. If the request handling circuitry 202 determines that the request is associated with the root node control proceeds to block 606. If the request handling circuitry 202 determines that the request is associated with the intermediate node control proceeds to block 608. Further, if the request handling circuitry 202 determines that the request is associated with the child node control proceeds to block 610.

FIG. 6B depicts a sub-process of block 606 of FIG. 6A. At block 612 the request handling circuitry 202 determines whether the root node can satisfy the request based on a first, second, and third value associated with the root node, and a number of resources associated with the request. For example, the first value can correspond to a node resource utilization counter of the root node, the second value can correspond to a sub-node resource counter of the root node, and the third value can correspond to a total resource capacity of the root node. To determine whether the root node can satisfy the request the request handling circuitry 202 compares a sum of the first value, the second value, and the number of resources associated with the request to the third value. If the request handling circuitry 202 determines that the root node can satisfy the request control proceeds to block 614. Alternatively, if the request handling circuitry 202 determines that the root node cannot satisfy the request control proceeds to block 618.

At block 614 the request handling circuitry 202 assigns the request to hardware resource associated with the root node. For example, the request handling circuitry 202 can assign the request to intermediate nodes or child nodes associated with the root node.

At block 616 the memory interface circuitry 204 updates the first value associated with the root node. For example, the memory interface circuitry 204 updates the first value based on the request.

If the request handling circuitry 202 determined that the root node cannot satisfy the request, at block 618 the memory interface circuitry 204 marks the request as not satisfied. For example, the memory interface circuitry 204 can put the request in a queue for further processing when resources become available.

FIG. 6C depicts a sub-process of block 608 of FIG. 6A. At block 610 the request handling circuitry 202 determines whether the root node can satisfy the request based on the first, second, and third value associated with the root node, and the number of resources associated with the request. If the request handling circuitry 202 determines that the root node can satisfy the request control proceeds to block 622. Alternatively, if the request handling circuitry 202 determines that the root node cannot satisfy the request control proceeds to block 630.

At block 622 the request handling circuitry 202 determines whether the intermediate node can satisfy the request based on a first, second, and third value associated with the intermediate node, and the number of resources associated with the request. For example, the first value can correspond to a node resource utilization counter of the intermediate node, the second value can correspond to a sub-node resource counter of the intermediate node, and the third value can correspond to a total resource capacity of the intermediate node. To determine whether the intermediate node can satisfy the request the request handling circuitry 202 compares a sum of the first value, the second value, and the number of resources associated with the request to the third value. If the request handling circuitry 202 determines that the intermediate node can satisfy the request control proceeds to block 624. Alternatively, if the request handling circuitry 202 determines that the intermediate node cannot satisfy the request control proceeds to block 630.

At block 624 the request handling circuitry 202 assigns the request to hardware resource associated with the intermediate node. For example, the request handling circuitry 202 can assign the request to child nodes associated with the intermediate node.

At block 626 the memory interface circuitry 204 updates the first value associated with the intermediate node. For example, the memory interface circuitry 204 updates the first value based on the request.

At block 628 the memory interface circuitry 204 updates the second value associated with the root node. For example, the memory interface circuitry 204 updates the second value based on the request.

If the request handling circuitry 202 determined that either the root node or the intermediate node cannot satisfy the request, at block 630 the memory interface circuitry 204 marks the request as not satisfied. For example, the memory interface circuitry 204 can put the request in a queue for further processing when resources become available.

FIG. 6D depicts a sub-process of block 608 of FIG. 6A. At block 632 the request handling circuitry 202 determines whether the root node can satisfy the request based on the first, second, and third value associated with the root node, and the number of resources associated with the request. If the request handling circuitry 202 determines that the root node can satisfy the request control proceeds to block 634. Alternatively, if the request handling circuitry 202 determines that the root node cannot satisfy the request control proceeds to block 646.

At block 634 the request handling circuitry 202 determines whether the intermediate node can satisfy the request based on the first, second, and third value associated with the root node, and the number of resources associated with the request. If the request handling circuitry 202 determines that the intermediate node can satisfy the request control proceeds to block 634. Alternatively, if the request handling circuitry 202 determines that the intermediate node cannot satisfy the request control proceeds to block 646.

At block 636 the request handling circuitry 202 determines whether the child node can satisfy the request based on a first, second, and third value associated with the child node, and the number of resources associated with the request. For example, the first value can correspond to a node resource utilization counter of the child node, the second value can correspond to a sub-node resource counter of the child node, and the third value can correspond to a total resource capacity of the child node. To determine whether the child node can satisfy the request the request handling circuitry 202 compares a sum of the first value, the second value, and the number of resources associated with the request to the third value. If the request handling circuitry 202 determines that the child node can satisfy the request control proceeds to block 638. Alternatively, if the request handling circuitry 202 determines that the child node cannot satisfy the request control proceeds to block 646.

At block 638 the request handling circuitry 202 assigns the request to hardware resource associated with the child node. For example, the request handling circuitry 202 can assign the request to cores associated with the child node.

At block 640 the memory interface circuitry 204 updates the first value associated with the child node. For example, the memory interface circuitry 204 updates the first value based on the request.

At block 642 the memory interface circuitry 204 updates the second value associated with the intermediate node. For example, the memory interface circuitry 204 updates the second value based on the request.

At block 644 the memory interface circuitry 204 updates the second value associated with the root node. For example, the memory interface circuitry 204 updates the second value based on the request.

If the request handling circuitry 202 determined that either the root node, the intermediate node, or the child node cannot satisfy the request, at block 646 the memory interface circuitry 204 marks the request as not satisfied. For example, the memory interface circuitry 204 can put the request in a queue for further processing when resources become available.

FIG. 7 is a block diagram of an example programmable circuitry platform 700 structured to execute and/or instantiate the example machine-readable instructions and/or the example operations of FIGS. 6A-6D to implement the resource management circuitry 102 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the request handling circuitry 202, the memory interface circuitry 204, and the resource monitoring circuitry 206.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 6A-6D, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 6A-6D to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 6A-6D.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 6A-6D but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6A-6D. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6A-6D. As such, the FPGA circuitry 900 may be configured and/or structured to effectively instantiate some or all of the operations/functions corresponding to the machine readable instructions of the flowchart(s) of FIGS. 6A-6D as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 6A-6D faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 6A-6D and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 6A-6D to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 6A-6D, and/or an ASIC may be configured and/or structured to perform third operation(s)/function(s) corresponding to a third portion of the machine readable instructions represented by the flowcharts of FIGS. 6A-6D.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

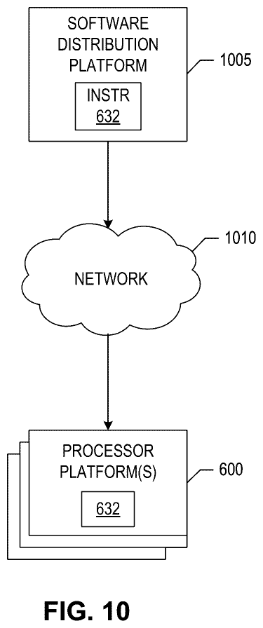

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 6A-6D, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 6A-6D, may be downloaded to the example programmable circuitry platform 700, which is to execute the machine readable instructions 732 to implement the resource management circuitry 102. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide for efficient tracking of computer resource utilization. Disclosed systems, apparatus, articles of manufacture, and methods improve the efficiency of using a computing device by enabling efficient tracking of computer resource utilization. Disclosed examples enable tracking of computer resources at multiple layers of software. For example, the tree based data structure enables detailed tracking of resources at nodes and sub-nodes of a computer system. The tree based data structure further enables requests for computer resources to be efficiently managed, therefore increasing overall computing speed of the computer system. Disclosed systems, apparatus, articles of manufacture, and methods are accordingly directed to one or more improvement(s) in the operation of a machine such as a computer or other electronic and/or mechanical device. Further examples and combinations thereof include the following:
Example 1 includes a non-transitory machine readable storage medium comprising instructions to cause programmable circuitry to at least determine whether a first request associated with a root node can be satisfied by at least a first intermediate node of the root node, after a determination that the first request can be satisfied, assign the first request to hardware resources associated with the root node and update a node resource utilization counter of the root node, determine whether a first child node of the first intermediate node can satisfy a second request associated with the first child node, and after the determination, assign the second request to hardware resources associated with the first child node and update a node resource utilization counter of the first child node, a sub-node resource utilization counter of the first intermediate node, and a sub-node resource utilization counter of the root node.
Example 2 includes the non-transitory machine readable storage medium of example 1, wherein the instructions are to cause the programmable circuitry to determine whether the first request can be satisfied by the first intermediate node or a second intermediate node of the root node.
Example 3 includes the non-transitory machine readable storage medium of example 2, wherein the determination that the first request can be satisfied is based on the node resource utilization counter of the root node, the sub-node resource utilization counter of the root node, and a total resource capacity of the root node.
Example 4 includes the non-transitory machine readable storage medium of example 3, wherein the determination that the first request can be satisfied is based on a comparison of the node resource utilization counter of the root node and the sub-node resource utilization counter of the root node to the total resource capacity of the root node.
Example 5 includes the apparatus of any one or more of examples 2-4, wherein the programmable circuitry is to determine whether a second child node of the first intermediate node and a third child node of the second intermediate node can satisfy a third request associated with the second child node and the third child node, and after a determination that second child node and the third child node can satisfy the first request, update a node resource utilization counter of the second child node, a node resource utilization counter of the third child node, the sub-node resource utilization counter of the first intermediate node, a sub-node resource utilization counter of the second intermediate node, and the sub-node resource utilization counter of the root node.
Example 6 includes the apparatus of any one or more of examples 1-5, wherein the child nodes are processors.
Example 7 includes the apparatus of any one or more of examples 1-6, where the first intermediate node is a socket.
Example 8 includes a system comprising a memory, processor circuitry including a first intermediate node, the first intermediate node associated with a root node of the processor circuitry, including a first child node and a second child node, and a second intermediate node, the second intermediate node associated with the root node, including a third child node and a fourth child node, programmable circuitry to at least one of instantiate or execute machine readable instructions to determine a first request associated with the root node can be satisfied by at least one of the first intermediate node or the second intermediate node, after a determination that the first request can be satisfied, update a first value of the root node, determine whether the first child node can satisfy a second request associated with the first child node, and after a determination that the first child node can satisfy the second request, update a first value of the first child node, a second value of the first intermediate node, and a second value of the root node.
Example 9 includes the system of example 8, wherein the first values are representative of resources utilized at the respective node.
Example 10 includes the apparatus of any one or more of examples 8-9, wherein the second values are representative of resources utilized at sub nodes of the respective node.
Example 11 includes the apparatus of any one or more of examples 8-10, wherein the determination that the first request can be satisfied is based on the first value of the root node, the second value of the root node, and a third value of the root node, where the third value is representative of total resources at the root node.
Example 12 includes the system of example 11, wherein the determination that the first request can be satisfied is based on a comparison of the first value of the root node and the second value of the root node to the third value of the root node.
Example 13 includes the apparatus of any one or more of examples 8-12, wherein the programmable circuitry is to determine whether the second child node and the third child node can satisfy a third request associated with the second child node and the third child node, and after a determination that second child node and the third child node can satisfy the first request, update a first value of the second child node, a first value of the third child node, the second value of the first intermediate node, a second value of the second intermediate node, and the second value of the root node.
Example 14 includes the apparatus of any one or more of examples 8-13, wherein the child nodes are processors.
Example 15 includes the apparatus of any one or more of examples 8-14, where the intermediate nodes are sockets.
Example 16 includes an apparatus comprising a first intermediate node of a root node including a first child node and a second child node, a second intermediate node of the root node including a third child node and a fourth child node, and a memory including utilization data, where the utilization data includes a plurality of first values representative of compute resources utilized at ones of the root node, the intermediate nodes, and the child nodes, a plurality of second values representative of compute resources utilized at sub-nodes of ones of the root node and the intermediate nodes, and a plurality of third values representative of total resources at ones of the root node, the intermediate nodes, and the child nodes.
Example 17 includes the apparatus of example 16, wherein the utilization data further includes a plurality of requests associated with the root node, the intermediate nodes, and the child nodes.
Example 18 includes the apparatus of any one or more of examples 16-17, wherein the utilization includes satisfied and unsatisfied requests.
Example 19 includes the apparatus of any one or more of examples 16-18, wherein the child nodes are processors.
Example 20 includes the apparatus of any one or more of examples 16-19, wherein the intermediate nodes are sockets.

What is claimed is:

1. A non-transitory machine readable storage medium comprising instructions to cause programmable circuitry to at least:
determine whether a first request associated with a root node can be satisfied by at least a first intermediate node of the root node;
after a determination that the first request can be satisfied, assign the first request to hardware resources associated with the root node and update a node resource utilization counter of the root node;
determine whether a first child node of the first intermediate node can satisfy a second request associated with the first child node; and
after the determination, assign the second request to hardware resources associated with the first child node and update a node resource utilization counter of the first child node, a sub-node resource utilization counter of the first intermediate node, and a sub-node resource utilization counter of the root node.

2. The non-transitory machine readable storage medium of claim 1, wherein the instructions are to cause the programmable circuitry to determine whether the first request can be satisfied by the first intermediate node or a second intermediate node of the root node.

3. The non-transitory machine readable storage medium of claim 2, wherein the determination that the first request can be satisfied is based on the node resource utilization counter of the root node, the sub-node resource utilization counter of the root node, and a total resource capacity of the root node.

4. The non-transitory machine readable storage medium of claim 3, wherein the determination that the first request can be satisfied is based on a comparison of the node resource utilization counter of the root node and the sub-node resource utilization counter of the root node to the total resource capacity of the root node.

5. The non-transitory machine readable storage medium of claim 2, wherein the programmable circuitry is to:
determine whether a second child node of the first intermediate node and a third child node of the second intermediate node can satisfy a third request associated with the second child node and the third child node; and
after a determination that second child node and the third child node can satisfy the first request, update a node resource utilization counter of the second child node, a node resource utilization counter of the third child node, the sub-node resource utilization counter of the first intermediate node, a sub-node resource utilization counter of the second intermediate node, and the sub-node resource utilization counter of the root node.

6. The non-transitory machine readable storage medium of claim 1, wherein the child nodes are processors.

7. The non-transitory machine readable storage medium of claim 1, where the first intermediate node is a socket.

8. A system comprising:
a memory;
processor circuitry including:
a first intermediate node, the first intermediate node associated with a root node of the processor circuitry, including a first child node and a second child node; and
a second intermediate node, the second intermediate node associated with the root node, including a third child node and a fourth child node;
programmable circuitry to at least one of instantiate or execute machine readable instructions to:
determine a first request associated with the root node can be satisfied by at least one of the first intermediate node or the second intermediate node;
after a determination that the first request can be satisfied, update a first value of the root node;
determine whether the first child node can satisfy a second request associated with the first child node; and
after a determination that the first child node can satisfy the second request, update a first value of the first child node, a second value of the first intermediate node, and a second value of the root node.

9. The system of claim 8, wherein the node resource utilization counters are representative of resources utilized at the respective node.

10. The system of claim 8, wherein the sub-node resource utilization counters are representative of resources utilized at sub nodes of the respective node.

11. The system of claim 8, wherein the determination that the first request can be satisfied is based on the first value of the root node, the second value of the root node, and a third value of the root node, where the third value is representative of total resources at the root node.

12. The system of claim 11, wherein the determination that the first request can be satisfied is based on a comparison of the first value of the root node and the second value of the root node to the third value of the root node.

13. The system of claim 8, wherein the programmable circuitry is to:
determine whether the second child node and the third child node can satisfy a third request associated with the second child node and the third child node; and
after a determination that second child node and the third child node can satisfy the first request, update a first value of the second child node, a first value of the third child node, the second value of the first intermediate node, a second value of the second intermediate node, and the second value of the root node.

14. The system of claim 8, wherein the child nodes are processors.

15. The system of claim 8, where the intermediate nodes are sockets.

16. An apparatus comprising:
a first intermediate node of a root node including a first child node and a second child node;
a second intermediate node of the root node including a third child node and a fourth child node; and
a memory including utilization data, where the utilization data includes:
a plurality of first values representative of compute resources utilized at ones of the root node, the intermediate nodes, and the child nodes;
a plurality of second values representative of compute resources utilized at sub-nodes of ones of the root node and the intermediate nodes; and
a plurality of third values representative of total resources at ones of the root node, the intermediate nodes, and the child nodes.

17. The apparatus of claim 16, wherein the utilization data further includes a plurality of requests associated with the root node, the intermediate nodes, and the child nodes.

18. The apparatus of claim 16, wherein the utilization includes satisfied and unsatisfied requests.

19. The apparatus of claim 16, wherein the child nodes are processors.

20. The apparatus of claim 16, wherein the intermediate nodes are sockets.
